(19) United States
(12) Patent Application Publication
(10) Pub. No.: US 2025/0069315 A1
(43) Pub. Date: Feb. 27, 2025

(54) ELECTRONIC APPARATUS AND METHOD FOR CONTROLLING THEREOF

(71) Applicant: SAMSUNG ELECTRONICS CO., LTD., Suwon-si (KR)

(72) Inventors: Seungki CHO, Suwon-si (KR); Sunggyu LEE, Suwon-si (KR); Han KANG, Suwon-si (KR); Jaemun SIM, Suwon-si (KR); Injae YU, Suwon-si (KR)

(73) Assignee: SAMSUNG ELECTRONICS CO., LTD., Suwon-si (KR)

(21) Appl. No.: 18/947,839

(22) Filed: Nov. 14, 2024

Related U.S. Application Data
(63) Continuation of application No. PCT/KR2023/004033, filed on Mar. 27, 2023.

(30) Foreign Application Priority Data
May 16, 2022 (KR) 10-2022-0059779
Jul. 6, 2022 (KR) 10-2022-0083211

(51) Int. Cl. G06T 15/00; G06T 7/20; G06V 10/44

(52) U.S. Cl. CPC G06T 15/00; G06T 7/20; G06V 10/44; G06V 2201/07

(57) ABSTRACT

An electronic apparatus, includes: one or more processors; and at least one memory storing instructions that, when executed by the one or more processors, cause the electronic apparatus to: obtain image frames in a user-captured image stored in the at least one memory; identify an object which includes motion information based on the image frames; obtain first feature information of the object from a first image frame from among the image frames; obtain a first avatar image corresponding to the object based on the first feature information; obtain second feature information of the object from a second image frame from among the image frames; obtain a second avatar image corresponding to the object based on the second feature information; and obtain a virtual space image based on the first avatar image and the second avatar image.

### CROSS-REFERENCE TO RELATED APPLICATIONS

This application is a by-pass continuation application of International Application No. PCT/KR2023/004033, filed on Mar. 27, 2023, which is based on and claims priority to Korean Patent Application No. 10-2022-0059779, filed in the Korean Intellectual Property Office on May 16, 2022, and Korean Patent Application No. 10-2022-0083211, filed in the Korean Intellectual Property Office on Jul. 6, 2022, the disclosures of which are incorporated by reference herein in their entireties.

### BACKGROUND

### 1. Field

The disclosure relates to an electronic apparatus and a method for controlling the same, and more particularly to an electronic apparatus that obtains an avatar image in a virtual space corresponding to an object included in an image data and a method for controlling the same.

### 2. Description of Related Art

As graphic technology develops, an actual person, an object, and the like may be realistically expressed with 3-dimensional (3D) graphics which exceed 2-dimensional (2D) graphics, and 3D graphic images may be utilized in games, movies, news, and the like to provide lively entertainment to users and viewers or information may be transferred in an intuitive way which is more easily understandable.

Developments in 3D graphic technology has led an implementation of a 3D virtual world, that is, a metaverse in which social, economic, and cultural activities like the real world are carried out by combining with on-line networking technology through servers rather than stopping at simple entertainment and transference of information.

Here, the metaverse is a concept which is one step more evolved than virtual reality, and encompasses all concepts which go beyond acts of entertainment using avatars to performing various activities that are carried out in an actual real world using their respective avatars within the virtual space. That is, another world may come to exist within the on-line virtual space.

The metaverse, which is technology that can be utilized in the implementation of virtual reality, implements avatars and animation images which map and reflect motions of persons or objects included in an image as is from image data which captured an actual person or object and implements the same in the virtual space.

There is a need to implement the avatars and animation data as described above to avatars and animation images in the virtual space based on feature information on motions of a whole body rather than a portion of the body such as a face, an upper body, and the like of a person for implementing in the virtual space.

In addition, in order for a process of generating avatars and animation images in the virtual space to be more efficient and simply carried out, there is a need to utilize a method of extracting feature information from a separate motion sensor for detecting a motion of a person or an object, image data captured in real-time without a body suit, or image data which is pre-stored in an apparatus.

Accordingly, there is a demand for a method of generating virtual space images which include avatars and animation images corresponding to persons or objects included in the image data by extracting feature information on motions of the persons or objects included in the image data.

### SUMMARY

According to an aspect of the disclosure, an electronic apparatus, includes: one or more processors; and at least one memory storing instructions that, when executed by the one or more processors, cause the electronic apparatus to: obtain a plurality of image frames in a user-captured image stored in the at least one memory; identify an object which includes motion information based on the plurality of image frames; obtain first feature information of the object from a first image frame from among the plurality of image frames; obtain a first avatar image corresponding to the object based on the first feature information; obtain second feature information of the object from a second image frame from among the plurality of image frames; obtain a second avatar image corresponding to the object based on the second feature information; and obtain a virtual space image based on the first avatar image and the second avatar image.

The one or more processors may be configured to execute the instructions to cause the electronic apparatus to: identify, based on the plurality of image frames, a first object including first motion information and a second object including second motion information, obtain, from the first image frame, third feature information of the first object based on a first extraction method and fourth feature information of the second object based on a second extraction method; obtain, from the second image frame, fifth feature information of the first object based on the first extraction method and sixth feature information of the second object based on the second extraction method; and obtain a third avatar image corresponding to the first object based on the third feature information and the fifth feature information, and obtain a fourth avatar image corresponding to the second object based on the fourth feature information and the sixth feature information.

The one or more processors may be configured to execute the instructions to cause the electronic apparatus to: obtain from the first image frame, based on a first object including first motion information and a second object including second motion information being identified based on the plurality of image frames, third feature information of the first object and fourth feature information of the second object; obtain from the second image frame, fifth feature information of the first object and sixth feature information of the second object; obtain a third avatar image corresponding to the third feature information and the fifth feature information based on first motion generating information, and obtain a fourth avatar image corresponding to the fourth feature information and the sixth feature information based on second motion generating information.

The first motion generating information may include first motion constraint information, the second motion generating information may include second motion constraint information, and the first motion constraint information may be different from the second motion constraint information.

The one or more processors may be configured to execute the instructions to cause the electronic apparatus to: identify a first motion type of the object based on the first feature information; identify first pre-defined avatar motion information corresponding to the first motion type; obtain the first avatar image based on the first pre-defined avatar motion information; identify a second motion type of the object based on the second feature information; identify second pre-defined avatar motion information corresponding to the second motion type; obtain the second avatar image based on the second pre-defined avatar motion information; obtain an intermediate avatar image of the first avatar image and the second avatar image based on the first avatar image and the second avatar image; and obtain a final avatar image based on the first avatar image, the second avatar image, and the intermediate avatar image.

The first pre-defined avatar motion information may include a first motion image, and the second pre-defined avatar motion information may include a second motion image. The one or more processors may be configured to execute the instructions to cause the electronic apparatus to: identify a first avatar motion image corresponding to the first motion type based on the first pre-defined avatar motion information, and identify a second avatar motion image corresponding to the second motion type based on the second pre-defined avatar motion information; obtain the first avatar image based on the first avatar motion image and information on the object; obtain the second avatar image based on the second avatar motion image and the information on the object; obtain the intermediate avatar image of the first avatar image and the second avatar image based on the first avatar image and the second avatar image; and obtain the final avatar image based on the first avatar image, the second avatar image, and the intermediate avatar image.

Pre-defined avatar motion information corresponding to a plurality of motion types may be stored in the at least one memory or an external apparatus, and the one or more processors may be configured to execute the instructions to cause the electronic apparatus to: transmit, based on the pre-defined avatar motion information being stored in the external apparatus, information on the first motion type and the second motion type to the external apparatus, and receive the first pre-defined avatar motion information and the second pre-defined avatar motion information from the external apparatus.

The electronic apparatus may further include a display, and the one or more processors may be configured to execute the instructions to cause the electronic apparatus to control the display to display the virtual space image.

The one or more processors may be configured to execute the instructions to cause the electronic apparatus to: obtain a first avatar motion image corresponding to the object based on the first feature information; obtain a second avatar motion image corresponding to the object based on the second feature information; and obtain the virtual space image by applying temporal filtering to the first avatar motion image and the second avatar motion image.

According to an aspect of the disclosure, a control method of an electronic apparatus, includes: identifying an object which includes motion information based on a plurality of image frames in a user-captured image; obtaining first feature information of the object from a first image frame from among the plurality of image frames; obtaining a first avatar image corresponding to the object based on the first feature information; obtaining second feature information of the object from a second image frame from among the plurality of image frames; obtaining a second avatar image corresponding to the object based on the second feature information; and obtaining a virtual space image based on the first avatar image and the second avatar image.

The identifying the object may include identifying, based on the plurality of image frames, a first object including first motion information and a second object including second motion information; the obtaining the first feature information may include obtaining, from the first image frame, third feature information of the first object based on a first extraction method and fourth feature information of the second object based on a second extraction method; the obtaining the second feature information may include obtaining, from the second image frame, fifth feature information of the first object based on the first extraction method and sixth feature information of the second object based on the second extraction method; and the obtaining the first avatar image and the obtaining the second avatar image may include obtaining a third avatar image corresponding to the first object based on the third feature information and the fifth feature information, and obtaining a fourth avatar image corresponding to the second object based on the fourth feature information and the sixth feature information.

The identifying the object may include identifying, based on the plurality of image frames, a first object including first motion information and a second object including second motion information; the obtaining the first feature information may include obtaining, from the first image frame, third feature information of the first object and fourth feature information of the second object; the obtaining the second feature information may include obtaining, from the second image frame, fifth feature information of the first object and sixth feature information of the second object; and the obtaining the first avatar image and the obtaining the second avatar image may include obtaining a third avatar image corresponding to the third feature information and the fifth feature information based on first motion generating information, and obtaining a fourth avatar image corresponding to the fourth feature information and the sixth feature information based on second motion generating information.

The first motion generating information may include first motion constraint information, the second motion generating information may include second motion constraint information, and the first motion constraint information may be different from the second motion constraint information.

The obtaining the first avatar image may include: identifying a first motion type of the object based on the first feature information; identifying first pre-defined avatar motion information corresponding to the first motion type; and obtaining the first avatar image based on the first pre-defined avatar motion information. The obtaining the second avatar image may include: identifying a second motion type of the object based on the second feature information; identifying second pre-defined avatar motion information corresponding to the second motion type; and obtaining the second avatar image based on the second pre-defined avatar motion information. The obtaining the virtual space image may include: obtaining an intermediate avatar image of the first avatar image and the second avatar image based on the first avatar image and the second avatar image; and obtaining a final avatar image based on the first avatar image, the second avatar image, and the intermediate avatar image.

The first pre-defined avatar motion information may include a first motion image, and the second pre-defined avatar motion information may include a second motion image. The obtaining the first avatar image may include: identifying a first avatar motion image corresponding to the first motion type based on the first pre-defined avatar motion information; and obtaining the first avatar image based on the first avatar motion image and information on the object. The obtaining the second avatar image may include: identifying a second avatar motion image corresponding to the second motion type based on the second pre-defined avatar motion information; and obtaining the second avatar image based on the second avatar motion image and the information on the object. The obtaining the virtual space image may include: obtaining the intermediate avatar image of the first avatar image and the second avatar image based on the first avatar image and the second avatar image; and obtaining the final avatar image based on the first avatar image, the second avatar image, and the intermediate avatar image.

The obtaining the first avatar image and the obtaining the second avatar image may include transmitting, based on the pre-defined avatar motion information being stored in an external apparatus, information on the first motion type and the second motion type to the external apparatus, and receiving the first pre-defined avatar motion information and the second pre-defined avatar motion information from the external apparatus.

The control method may further include displaying the virtual space image.

The control method may further include: obtaining a first avatar motion image corresponding to the object based on the obtained first feature information; and obtaining a second avatar motion image corresponding to the object based on the obtained second feature information, and the obtaining the virtual space image may include obtaining the virtual space image by applying temporal filtering to the first avatar motion image and the second avatar motion image.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram illustrating an avatar image in virtual space generated based on image data according to an embodiment of the disclosure;

FIG. 2A is a block diagram illustrating a configuration of an electronic apparatus according to an embodiment of the disclosure;

FIG. 2B is a block diagram illustrating a configuration of an electronic apparatus according to an embodiment of the disclosure;

FIG. 3 is a diagram illustrating an avatar image in virtual space corresponding to a plurality of objects included in image data according to an embodiment of the disclosure;

FIG. 4 is a diagram illustrating an avatar image obtaining process in virtual space corresponding to a plurality of objects included in image data according to an embodiment of the disclosure;

FIG. 5 is a diagram illustrating an avatar image in virtual space obtained based on a motion of an object included in image data and pre-defined avatar motion information according to an embodiment of the disclosure;

FIG. 6 is a diagram illustrating a process of obtaining an avatar image in virtual space based on a motion of an object included in image data and pre-defined avatar motion information according to an embodiment of the disclosure;

FIG. 7 is a diagram illustrating an avatar image in virtual space generated based on image data according to an embodiment of the disclosure;

FIG. 8 is a diagram illustrating an avatar image in virtual space generated based on image data according to an embodiment of the disclosure;

FIG. 9 is a diagram illustrating an avatar image in virtual space generated based on image data according to an embodiment of the disclosure;

FIG. 10 is a flowchart illustrating an avatar image obtaining process in virtual space corresponding to a plurality of objects included in image data according to an embodiment of the disclosure;

FIG. 11 is a flowchart illustrating an avatar image obtaining process in virtual space by correcting feature information of objects included in image data according to an embodiment of the disclosure;

FIG. 12 is a flowchart illustrating a process of obtaining an avatar image in virtual space based on a motion of an object included in image data and pre-defined avatar motion information according to an embodiment of the disclosure; and

FIG. 13 is a flowchart illustrating an operation of an electronic apparatus according to an embodiment of the disclosure.

### DETAILED DESCRIPTION

The embodiments described in the disclosure, and the configurations shown in the drawings, are only examples of embodiments, and various modifications may be made without departing from the scope and spirit of the disclosure.

Various modifications may be made to the embodiments of the disclosure, and there may be various types of embodiments. Accordingly, embodiments will be illustrated in drawings, and described in detail in the detailed description. However, it should be noted that the various embodiments are not for limiting the scope to a specific embodiment, but they should be interpreted to include all modifications, equivalents or alternatives of the embodiments disclosed herein. With respect to the description of the drawings, like reference numerals may be used to indicate like elements.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been used merely to describe one or more embodiments, and are not intended to limit the scope of protection. A singular expression includes a plural expression, unless otherwise specified in context.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

In the disclosure, expressions such as “A or B”, “at least one of A and/or B”, or “one or more of A and/or B” may include all possible combinations of the items listed together. For example, “A or B”, “at least one of A and B”, or “at least one of A or B” may refer to all cases including (1) at least one A, (2) at least one B, or (3) both of at least one A and at least one B.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

On the other hand, when the certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ,” “having the capacity to . . . ,” “designed to . . . ,” “adapted to . . . ,” “made to . . . ,” or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “a processor configured to (or set up to) perform A, B, or C” may mean a dedicated processor for performing a relevant operation (e.g., embedded processor), or a generic-purpose processor (e.g., a central processing unit (CPU) or an application processor) capable of performing the relevant operations by executing one or more software programs stored in a memory device.

The term ‘module’ or ‘part’ used herein perform at least one function or operation, and may be implemented with a hardware or software, or implemented with a combination of hardware and software. In addition, a plurality of ‘modules’ or a plurality of ‘parts’, excluding a ‘module’ or a ‘part’ may be integrated in at least one module and implemented as at least one processor.

Meanwhile, the various elements and areas of the drawings have been schematically illustrated. Accordingly, the technical spirit of the disclosure is not limited by relative sizes and distances illustrated in the accompanied drawings.

An embodiment of the disclosure will be described in detail below with reference to the accompanied drawings to aid in the understanding of those of ordinary skill in the art.

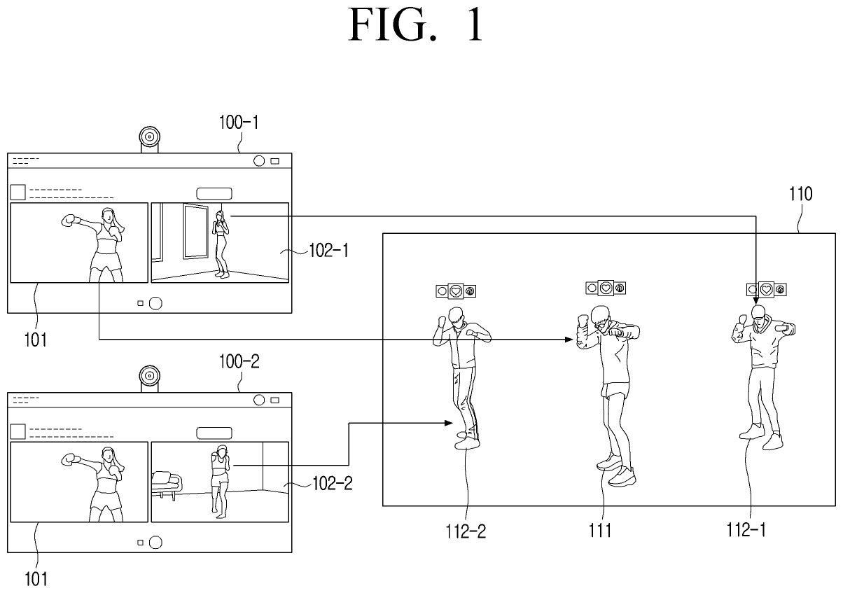

FIG. 1 is a diagram illustrating an avatar image in virtual space generated based on image data according to an embodiment of the disclosure.

Referring to FIG. 1, a plurality of users may exercise together using each of their avatar images through an on-line connection in a virtual space from their respective spaces (e.g., homes) without actually meeting.

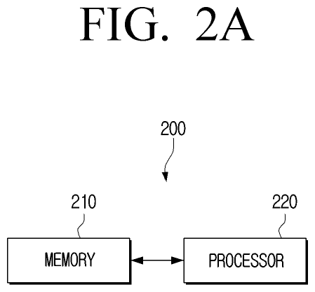

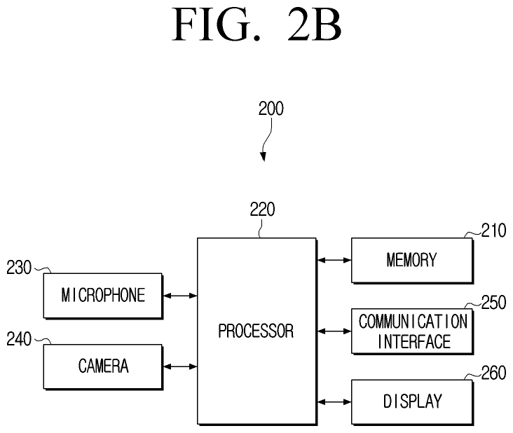

Users may follow exercise motions of a coach while viewing an exercise image 101 of the coach displayed on screens 100-1 and 100-2 of their respective electronic apparatuses 200 (FIG. 2). Here, an electronic apparatus 200 may display, not only the exercise image 101 of the coach on the screens 100-1 and 100-2 of the electronic apparatus 200, but images 102-1 and 102-2 which captured the user exercising following the exercise image of the coach may also be displayed together therewith.

The electronic apparatus 200 or an external apparatus may obtain feature information of a motion of a person included in an image from the exercise image 101 of the coach and the images 102-1 and 102-2 which captured the user exercising, and generate avatar images 111, 112-1, and 112-2 in virtual space based on the obtained feature information. The electronic apparatus 200 may display the generated avatar images 111, 112-1, and 112-2 on a screen.

Accordingly, the coach and each user may observe each other and follow the motions of other users through the avatar images 111, 112-1, and 112-2 in virtual space, and the coach may also observe the motions of each user and inform and correct the motions in greater detail.

As described above, the electronic apparatus 200 may generate an avatar image in virtual space and display on the screen by obtaining feature information on motions of objects (e.g., a person, an object) included in image data.

The electronic apparatus 200 that generates the avatar image in virtual space by obtaining feature information on motions of objects included in the image data according to an embodiment of the disclosure may include at least one from among, for example, a smartphone, a tablet personal computer (PC), a laptop PC, a netbook computer, a mobile medical device, a wearable device, a smart TV, an IPTV, and a media box (e.g., Samsung HomeSync™, Apple TV™, or Google TV™), but is not limited thereto, and the electronic apparatus 200 may be a server apparatus.

The electronic apparatus 200 may be formed as a system apparatus in which a plurality of apparatuses are connected in a wired or wireless communication method, and may carry out motions for performing one or more functions by being connected with other external devices.

The motions performed by each element included in the electronic apparatus 200 will be described in detail in both FIG. 2A and FIG. 2B.

FIG. 2A is a block diagram illustrating a configuration of the electronic apparatus 200 according to an embodiment of the disclosure.

Referring to FIG. 2A, the electronic apparatus 200 may include a memory 210 and a processor 220.

The memory 210 may temporarily or non-temporarily store various programs or data, and transfer stored information to the processor 220 according to a call of the processor 220. In addition, the memory 210 may store various information necessary in computing, processing, control operations, or the like of the processor 220 in electrical format.

The memory 210 may include at least one from among, for example, a main memory apparatus and an auxiliary memory apparatus. The main memory apparatus may be implemented using a semiconductor storage medium such as a read only memory (ROM) and/or a random access memory (RAM). The ROM may include, for example, and without limitation, a general ROM, an erasable and programmable ROM (EPROM), an electrically erasable and programmable ROM (EEPROM), a MASK-ROM, or the like. The RAM may include, for example, and without limitation, a dynamic RAM (DRAM), a static RAM (SRAM), or the like. The auxiliary memory apparatus may be implemented using an optical media such as, for example, and without limitation, a flash memory 210 apparatus, a secure digital (SD) card, a solid state drive (SSD), a hard disc drive (HDD), a magnetic drum, a compact disc (CD), a DVD or laser disc, or the like, or at least one storage medium capable of storing data permanently or semi-permanently such as, for example, and without limitation, a magnetic tape, a magneto-optical disc, a floppy disk, or the like.

The memory 210 may store image data which includes a plurality of image frames. The memory 210 may store feature information of an object included in the plurality of image frames. Here, the feature information of an object may include at least one from among motion information of the object or exterior information of the object. The memory 210 may store an avatar image obtained based on a motion type obtained based on the feature information of the object or the feature information of the object. The memory 210 may store pre-defined avatar motion information corresponding to the motion type of the object and a motion image included in the pre-defined avatar motion information. In addition thereto, the memory 210 may store temporal filtering information and motion constraint information used in correcting/generating an avatar image obtained based on the feature information of the object.

One or more processors 220 (hereinafter, referred to as ‘processor’) may control an overall operation of the electronic apparatus 200. The processor 220 may be connected with configurations of the electronic apparatus 200 which include the memory 210 as described above, and by executing at least one instruction stored in the memory 210 as described above, control the overall operation of the electronic apparatus 200. The processor 220 may not only be implemented with one processor 220 but implemented with a plurality of processors 220.

The processor 220 may be implemented in various methods. For example, the processor 220 may be implemented as at least one from among an application specific integrated circuit (ASIC), an embedded processor 220, a microprocessor 220, a hardware control logic, a hardware finite state machine (FSM), and a digital signal processor (DSP) 220.

Meanwhile, the processor 220 in the disclosure may include one or more from among a central processing unit (CPU) that processes digital signals, a micro controller unit (MCU), a micro processing unit (MPU), a controller, an application processor (AP) 220, a communication processor (CP) 220, or an ARM processor 220, or may be defined by the relevant term. In addition, the processor 220 may be implemented as a System on Chip (SoC) or a large scale integration (LSI) in which a processing algorithm is embedded, and may be implemented in a form of a field programmable gate array (FPGA). The processor 220 may perform various functions by executing computer executable instructions stored in the memory 210. In addition thereto, the processor 220 may include at least one from among a graphics-processing unit (GPU), or a neural processing unit (NPU), a visual processing unit (VPU) which are separate artificial intelligence (AI) dedicated processors 220 for performing an artificial intelligence function.

The processor 220 may obtain a plurality of image frames included in a user-captured image. Here, the user-captured image may be an image obtained through a camera 240 in real-time or received from the memory 210 or an external server apparatus.

The processor 220 may identify an object including motion information based on the plurality of image frames. Here, the object including motion information may be an object having motion of greater than or equal to a size through a plurality of frames. For example, the processor 220 may identify a motion vector of an object from a previous frame and a current frame, and identify the object with a motion greater than or equal to a size based on the identified motion vector. The motion information may include information on various motions such as a change in length, a change in angle, a change is arrangement, and the like of the object.

The processor 220 may obtain first feature information of an object identified from a first image frame from among the plurality of image frames, and obtain a first avatar image corresponding to the identified object based on the obtained first feature information.

The processor 220 may obtain second feature information of an object identified from a second image frame from among the plurality of image frames, and obtain a second avatar image corresponding to the identified object based on the obtained second feature information.

The first feature information may include information on at least one from among a form, shape, and length of an object, an angle of a bending portion which is included in the object, a position of each portion, a position of a joint, a bending portion or a characteristic portion that form the object that is identified from the first image frame. The second feature information may include information on at least one from among a form, a shape, and a length of an object, an angle of a bending portion which is included in the object, a position of each portion, a position of a joint, a bending portion or a characteristic portion that form the object that is identified from the second image frame.

The processor 220 may obtain a first avatar image in virtual space corresponding to the object based on information on the form, the shape, the length, the angle, an arrangement, and the like of the object identified from the first image frame, and obtain a second avatar image in virtual space corresponding to the object based on information on the form, the shape, the length, the angle, the arrangement, and the like of the object identified from the second image frame. That is, the first avatar image and the second avatar image may be avatar images indicating instantaneous motions at different time slots from each other from among a process of motions of one object included in the image.

The processor 220 may obtain a virtual space image based on the first avatar image and the second avatar image. The processor 220 may obtain the virtual space image formed with consecutive motions based on the first avatar image and the second avatar image which indicate instantaneous motions from different time slots from each other of one object included in the image.

FIG. 2B is a block diagram illustrating a configuration of the electronic apparatus 200 according to an embodiment of the disclosure.

The microphone 230 may refer to a module that obtains sound and converts to an electric signal, and may be a condenser microphone 230, a ribbon microphone 230, a moving-coil microphone 230, a piezoelectric device microphone 230, a carbon microphone 230, or a micro electro mechanical system (MEMS) microphone 230. In addition, the above may be implemented in an omnidirectional method, a bidirectional method, a unidirectional method, a sub cardioid method, a super cardioid method, or a hyper cardioid method.

For example, the processor 220 may obtain a voice through the microphone 230 in real-time, and obtain audio information corresponding to the obtained voice. The processor 220 may obtain an avatar image in virtual space corresponding to an object and audio data corresponding to the avatar image based on the obtained audio information and image data. However, the microphone 230 may not always be included in the electronic apparatus 200, and the processor 220 may obtain the audio data obtained through the microphone 230 included in the electronic apparatus by performing connection in communication with the external apparatus.

The camera 240 may capture a still image and a moving image. According to an embodiment, a camera 240 module may include one or more lenses, an image sensor, an image signal processor, or a flash.

The processor 220 may obtain image data by capturing an object (e.g., a person, an object), with the camera 240. The processor 220 may obtain an avatar image corresponding to the object based on feature information of the object included in the obtained image data. However, the electronic apparatus 200 may not necessarily include the camera 240, and the processor 220 may obtain the image data that captured the object by being connected with a separate external electronic apparatus 200 that includes the camera 240 capable of capturing the object in a wired or wireless manner.

The communication interface 250 may include a wireless communication interface, a wired communication interface, or an input interface. The wireless communication interface may perform communication with various external apparatuses using a wireless communication technology or a mobile communication technology. For the wireless communication technology, Bluetooth, Bluetooth Low Energy, CAN communication, Wi-Fi, Wi-Fi Direct, an ultra-wide band (UWB), ZigBee, infrared data association (IrDA), near field communication (NFC), and the like may be included as an example, and for the mobile communication technology, 3rd Generation Partnership Project (3GPP), Wi-Max, Long Term Evolution (LTE), 5th Generation (5G), and the like may be included. The wireless communication interface may be implemented using an antenna which can transmit electromagnetic waves to the outside or receive the electromagnetic waves transferred from the outside, a communication chip, a substrate, and the like.

The wired communication interface may perform communication with various external apparatuses based on a wired communication network. Here, the wired communication network may be implemented using physical cables such as, for example, and without limitation, a pair cable, a coaxial cable, an optical fiber cable, an Ethernet cable, or the like.

The electronic apparatus 200 may include the wireless communication interface, the wired communication interface. In addition thereto, the electronic apparatus 200 may be provided with an integrated communication interface 250 which supports both a wireless connection by the wireless communication interface and a wired connection by the wired communication interface.

The electronic apparatus 200 may not be limited to including one communication interface 250 which performs connection in communication in one type of method, and may include a plurality of communication interfaces 250.

The processor 220 may perform communication with various external electronic apparatuses 200 or a server present indoors or outdoors through the communication interface 250.

The processor 220 may transmit to the external electronic apparatus 200 or the server or receive from external electronic apparatus 200 or the server at least one from among image data, an image frame included in the image data, feature information or motion information of an object included in the image frame, pre-defined avatar motion information, a motion image included in the pre-defined avatar motion information, temporal filtering information, motion constraint information, or an avatar image corresponding to the object to the electronic apparatus 200 or the server by performing connection in communication with the external electronic apparatus 200 or the server through the communication interface 250. However, without being limited to the above, the processor 220 may transmit data necessary in implementing images and audio in virtual space or receive the same from the external electronic apparatus 200 or the server by performing connection in communication with the external electronic apparatus 200 or the server through the communication interface 250.

A display 260 may include display 260 panels of various types such as, for example, and without limitation, a liquid crystal display (LCD) panel, an organic light emitting diode (OLED) panel, an active-matrix organic light-emitting diode (AM-OLED), a liquid crystal on silicon (LcoS), a quantum dot light-emitting diode (QLED) and a digital light processing (DLP), a plasma display panel (PDP) panel, an inorganic LED panel, a micro LED panel, and the like, but is not limited thereto. Meanwhile, the display 260 may form a touch panel together with a touch screen, and may be formed of a flexible panel.

The processor 220 may control the display 260 to display the virtual space image obtained based on the first avatar image and the second avatar image corresponding to the object included in the image frame.

As described above, the processor 220 may identify feature information of an object included in the image frame through the various elements included in the electronic apparatus 200 or the external apparatus, and generate the virtual space image included with the avatar image corresponding to the object based on the feature information of the identified object. In addition, the processor 220 may store the generated virtual space image in the memory 210 or transmit to the external apparatus such as the server, or display through the display 260.

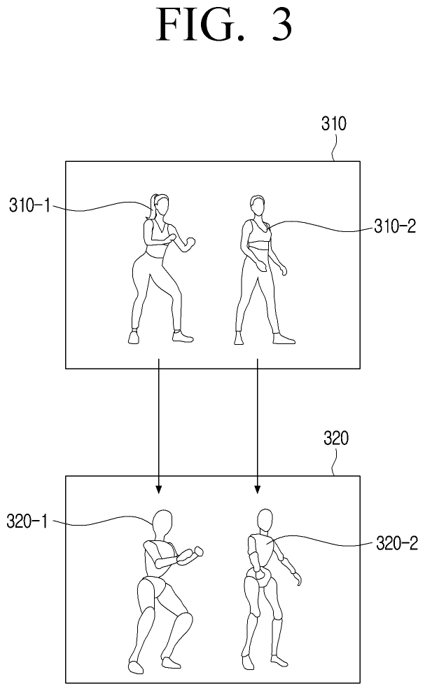

A process of the processor 220 for obtaining the virtual space image that includes the avatar image corresponding to the object included in the image will be described in detail together with FIG. 3 to FIG. 6.

FIG. 3 is a diagram illustrating an avatar image in virtual space corresponding to a plurality of objects included in image data according to an embodiment of the disclosure.

Referring to FIG. 3, the processor 220 may identify a first object 310-1 and a second object 310-2 including motion information based on at least one image frame 310. Here, the first object 310-1 and the second object 310-2 may be different persons or objects from each other. For example, the processor 220 may obtain a plurality of image frames from an image which is captured in real-time or pre-stored and identify the first object 310-1 and the second object 310-2 including motion information based on a motion vector obtained through the plurality of image frames.

The processor 220 may obtain feature information of the first object 310-1 based on a first extraction method and obtain feature information of the second object 310-2 based on a second extraction method from the first image frame. The processor 220 may obtain feature information of the first object 310-1 based on the first extraction method and obtain feature information of the second object 310-2 based on the second extraction method from a second image frame. Here, the first image frame and the second image frame may be image frames different from each other included in one image data. For example, the first image frame and the second image frame may be frames that have different time stamps. Here, the feature information may be information on a form, a shape, and a length of an object, an angle of a bending portion which is included in the object, a position of each portion, a position of a joint, a bending portion or a characteristic portion that form the object, and the like.

The processor 220 may obtain an avatar image 320-1 corresponding to the first object 310-1 based on the feature information of the first object 310-1, and obtain an avatar image 320-2 corresponding to the second object 310-2 based on the feature information of the second object 310-2.

The first extraction method and the second extraction method may be methods different from each other of extracting feature information of an object from an image frame. For example, the first extraction method may be a method that extracts the feature information of the object by identifying a joint, a segment, and the like of the object as a feature point, and the second extraction method may be a method that extracts the feature information of the object by identifying an outer contour of the object, a characteristic of a portion of a body, and the like as the feature point.

As described above, if the processor 220 extracts feature information of objects in different extraction methods from each other for different objects 310-1 and 310-2 included in the image frame, a more accurate feature information may be extracted by utilizing a feature information extraction method that fits the unique characteristic of each object if the plurality of objects 310-1 and 310-2 are formed of objects 310-1 and 310-2 of different types from each other such as, for example, and without limitation, a person, an animal, a machine, other objects, and the like.

According to an embodiment, the processor 220 may obtain, based on the first object 310-1 and the second object 310-2 including motion information being identified based on a plurality of image frames, feature information of the first object 310-1 and feature information of the second object 310-2 from the first image frame, and obtain feature information of the first object 310-1 and feature information of the second object 310-2 from the second image frame.

In this case, the processor 220 may obtain the avatar image 320-1 corresponding to the feature information of the first object 310-1 based on first motion generating information, and obtain the avatar image 320-2 corresponding to the feature information of the second object 310-2 based on second motion generating information. Here, the first motion generating information and the second motion generating information may include different motion constraint information. The motion constraint information may be information on an angle to which the object can actually move, a length, and the like. According to an example, different motion constraint information may be pre-set based on a type of the object, a shape and size of the object, and the like. For example, if the object is a person, because an arm of a person can only be bent inwards and the maximum angle to which the arm can be spread is 180° (degrees), an avatar image corresponding to a person may be obtained based on the motion constraint information as described above. Even if it is an object of the same type (e.g., person), different motion information may be pre-stored according to a profile of the object (sex, estimated age, etc.). In addition thereto, the motion constraint information may be information on an angle to which limbs of each person and types of animals can move, an angle to which a head can move, an angle to which wings can move, a length of a body which can be stretched or spread to a maximum, a length of a body which can be folded or bent to a minimum, and the like. In addition thereto, the motion constraint information may be set differently according to a type of a background space of a virtual space image, a current context (e.g., time, surrounding environment information, etc.).

As described above, by obtaining an avatar image based on different motion generating information for each object, an effect of being able to obtain a more accurate virtual space image that fits the characteristics of each object may be obtained if the object consists of different types of persons, animals, objects, and the like.

As described above, based on the plurality of objects 310-1 and 310-2 being included in the image frame, the processor 220 may obtain and implement a virtual space image which more accurately coincides with an actual appearance which corresponds to each of the plurality of objects by applying different feature information extraction methods for each of the objects 310-1 and 310-2 or obtaining an avatar image based on the different motion generating information.

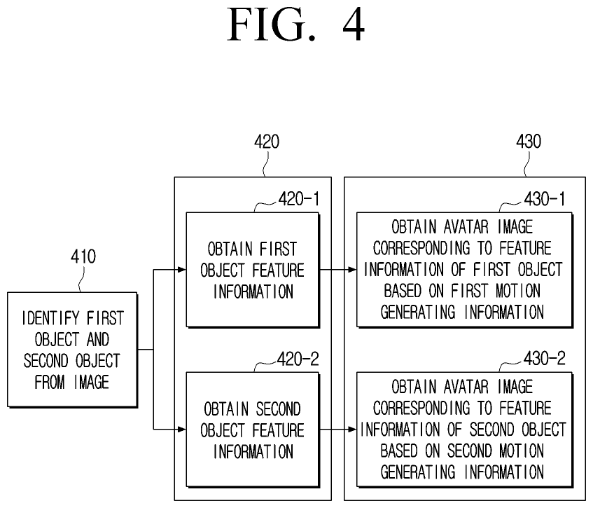

FIG. 4 is a diagram illustrating an avatar image obtaining process corresponding to a plurality of objects included in image data according to an embodiment of the disclosure.

Referring to FIG. 4, the processor 220 may identify a first object and a second object (410).

The processor 220 may obtain feature information of the first object and the second object included in the image frame (420). Here, the processor 220 may extract and object feature information in a method that better coincides with the characteristics and nature of each of the objects 310-1 and 310-2 by performing a process of obtaining the feature information of the first object 310-1 (420-1) and a process of obtaining the feature information of the second object 310-2 (420-2) in methods different from each other.

The processor 220 may obtain an avatar image corresponding to the feature information of each object based on the motion generating information of each of the objects 310-1 and 310-2 (430). Here, the processor 220 may obtain the first avatar image and the second avatar image corresponding to the first object 310-1 and the second object 310-2 based on different motion generating information of the first object 310-1 and the second object 310-2. Accordingly, the processor 220 may obtain an avatar image that better coincides with an actual appearance based on the type, the characteristic, and nature of each of the objects 310-1 and 310-2.

The processor 220 may store the virtual space image including the obtained avatar image in the memory 210, or transmit the same to the external apparatus such as the server, or control the display 260 for the same to be displayed on the display 260.

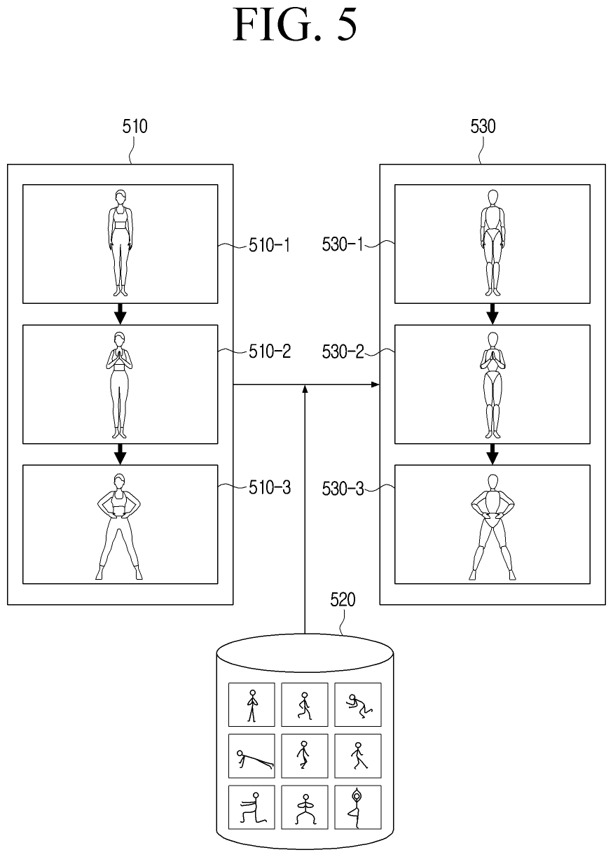

FIG. 5 is a diagram illustrating a method of obtaining an avatar image based on a motion of an object included in image data and pre-defined avatar motion information according to an embodiment of the disclosure.

The processor 220 may obtain information on a plurality of image frames from an image which is captured in real-time or pre-stored.

The processor 220 may identify an object 510 included in a plurality of image frames 510-1, 510-2, and 510-3. The processor 220 may identify a first motion type of the object based on first feature information of the identified object. The processor 220 may identify first pre-defined avatar motion information corresponding to the identified first motion type. The processor 220 may obtain motion information 530 of a first avatar based on pre-defined avatar motion information 520 constructed as a database in the memory 210 or the external apparatus.

The processor 220 may identify a second motion type of the object based on second feature information of the identified object. The processor 220 may identify second pre-defined avatar motion information corresponding to the identified second motion type.

Here, the motion type may indicate one from among various motions (or poses) taken by an object. The various motions (or poses) may include at least one from among consecutive motions or a still motion.

For example, the first motion type may be a first pose identified from a first image frame 510-1, and the second motion type may be a second pose identified from a second image frame 510-3.

The pre-defined avatar motion information may be pre-defined information indicating various motions of an object. For example, the motion information may include information on various pre-set motion types according to a type, an external form, and the like of an avatar (e.g., information which can indicate the motion type such as a motion vector), or information that includes motion images in virtual space corresponding to the motion type. However, information that includes motion information is not limited thereto, and may include various information on motions and forms of an object. The processor 220 may obtain first avatar motion information 530-1 corresponding to the first motion type identified from the first image frame 510-1 and second avatar motion information 530-3 corresponding to the second motion type identified from the second image frame 510-3 from the pre-defined avatar motion information 520 which is built as a database. Here, the first pre-defined avatar motion information 530-1 may include a first motion image, and the second pre-defined avatar motion information 530-3 may be a form that includes a second motion image.

According to an example, the processor 220 may identify motion information corresponding to the motion type of the identified object, and identify avatar motion information which has a similarity with the motion information of the object that is greater than or equal to a pre-set value as the avatar motion information corresponding to the motion information of the object. The processor 220 may obtain, based on the avatar motion information which has a similarity with the motion information of the object that is greater than or equal to the pre-set value not being present in the database stored in the memory 210 or the external apparatus, the avatar motion information corresponding to the motion information of the relevant object in another method. For example, the avatar image may be generated based on the motion information of the object or the feature information of the object.

The pre-defined avatar motion information corresponding respectively to a plurality of motion types may be stored in the memory 210 or the external apparatus. The processor 220 may transmit, based on the pre-defined motion information being stored in the external apparatus, information on the first motion type and the second motion type to the external apparatus such as the server by performing connection in communication with the external apparatus through the communication interface 250, and receive the first pre-defined avatar motion information and the second pre-defined avatar motion information from the external apparatus.

As described above, the processor 220 may identify the pre-defined avatar motion information corresponding to the motion type of the avatar, and obtain an avatar image that is taking a more standard and accurate motion by obtaining the avatar image based on the pre-defined avatar motion information.

According to an example, the processor 220 may obtain a first avatar image 530-1 based on the first avatar motion image and information on the identified object, and obtain a second avatar image 530-3 based on the second avatar motion image and information on the identified object. Here, the information on the object may include information on a sex, age, height, body type, clothing, accessories, and the like of the user which can be used to generate the external form of the avatar motion image.

According to an embodiment, the processor 220 may obtain an avatar image corresponding to an image frame 510-2 between the first image frame 510-1 and the second image frame 510-3 based on the first avatar image 530-1 obtained from the first image frame 510-1 and the second avatar image 530-3 obtained from the second image frame 510-3.

For example, the processor 220 may obtain an intermediate avatar image 530-2 of the first avatar image 530-1 and the second avatar image 530-3 based on the first avatar image 530-1 and the second avatar image 530-3. The processor 220 may obtain an virtual space image which includes a final avatar image based on the first avatar image 530-1, the second avatar image 530-3, and the intermediate avatar image 530-2.

Here, the intermediate avatar image 530-2 may be an avatar image indicating an intermediate motion of the first avatar image 530-1 and the second avatar image 530-3. For example, if the first avatar image 530-1 is an image of taking a first pose, and the second avatar image 530-3 is an image of taking a second pose, the intermediate avatar image 530-2 may be an image indicating an intermediate motion of the first pose and the second pose. Here, an angle of the arms in the intermediate avatar image 530-2 may be an angle which is in-between the first avatar image 530-1 and the second avatar image 530-3, and an extent to which the legs are bent may also be an extent which is in-between the first avatar image 530-1 and the second avatar image 530-3.

The processor 220 may obtain the intermediate avatar image 530-2 indicating the intermediate motion of the first avatar image 530-1 and the second avatar image 530-3 by performing linear interpolation of the feature information corresponding to the first avatar image 530-1 and the second avatar image 530-3 or applying and performing a temporal filtering to the feature information.

As described above, the processor 220 may obtain, after obtaining the intermediate avatar image 530-2, a virtual space image that is more natural and accurately corresponds to a motion of an actual object based on the first avatar image 530-1, the second avatar image 530-3, and the intermediate avatar image 530-2.

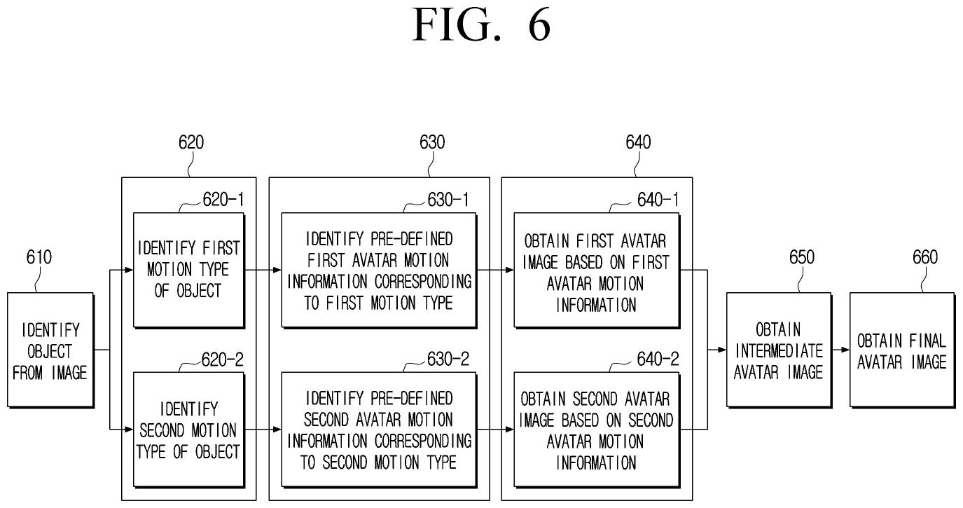

FIG. 6 is a diagram illustrating a process of obtaining an avatar image in virtual space based on a motion of an object included in image data and pre-defined avatar motion information according to an embodiment of the disclosure.

The processor 220 may identify an object in an image (610). The processor 220 may identify a motion type of the object (620). Here, the processor 220 may identify a first motion type of the object included in an image frame (620-1), and the processor 220 may identify a second motion type of the object which is the same as the object above included in the image frame and another image frame (S620-2).

The processor 220 may identify the first pre-defined avatar motion information corresponding to the first motion type (630-1). The processor 220 may identify the second pre-defined avatar motion information corresponding to the second motion type (630-2).

The processor 220 may obtain the first avatar image 530-1 based on first avatar motion information (640-1), and obtain the second avatar image 530-3 based on the second avatar motion information (640-2). The processor 220 may obtain the intermediate avatar image 530-2 indicating the intermediate motion of the first avatar image 530-1 and the second avatar image 530-3 (650). The processor 220 may obtain the final avatar image based on the first avatar image 530-1, the second avatar image 530-3, and the intermediate avatar image 530-2 (660), and obtain a virtual space image including the final avatar image.

The processor 220 may store the obtained virtual space image in the memory 210, or transmit the same to the external apparatus such as the server, or control the display 260 to display the same on the display 260.

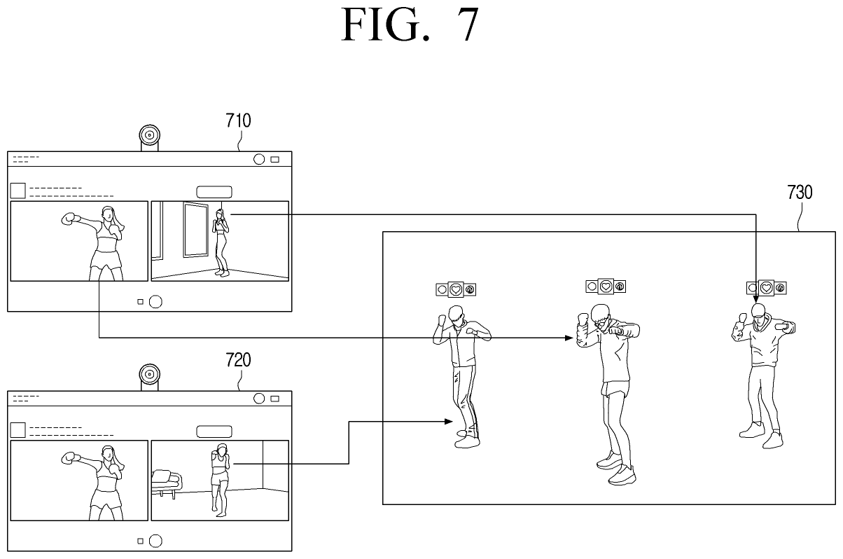

Various embodiments in which the processor 220 as described above may apply a motion of obtaining the avatar image corresponding to the object included in the image frame and the virtual space image will be described through FIG. 7 to FIG. 9.

FIG. 7 is a diagram illustrating an avatar image in virtual space generated based on image data according to an embodiment of the disclosure.

Referring to FIG. 7, the electronic apparatus 200 may obtain images 710 and 720 which captured a plurality of users and a coach exercising with the camera 240. The electronic apparatus 200 may obtain a virtual space image 730 including an avatar image by extracting and identifying feature information on the motions of the plurality of users and the coach included in the obtained images 710 and 720. Based on the electronic apparatus 200 controlling the display 260 to display the obtained virtual space image 730, what motions are being taken by a number of people that are currently on-line may be observed in real-time by the plurality of users and the coach.

Accordingly, the plurality of users may be able to take more accurate motions while observing the motions of one another, and because the coach is also able to closely observe and correct the motions that are currently being taken by the plurality of users, there may be an effect similar to actually exercising in one space.

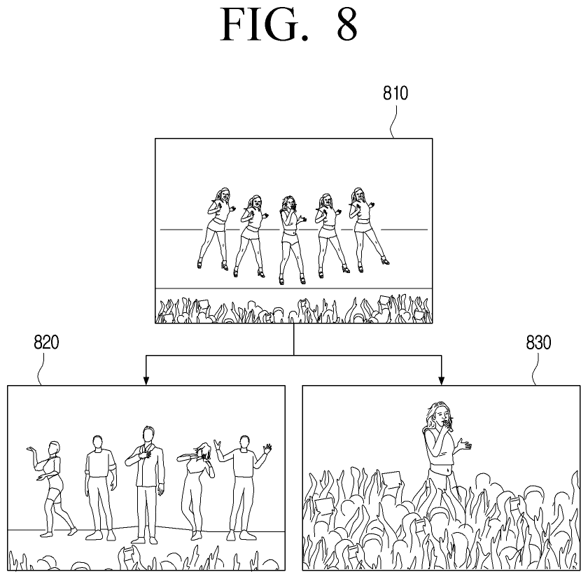

FIG. 8 is a diagram illustrating an avatar image in virtual space generated based on image data according to an embodiment of the disclosure.

The electronic apparatus 200 may obtain an image 810 which captured singers performing on stage and audience in audience seats in a concert scene with the camera 240. The electronic apparatus 200 may obtain virtual space images 820 and 830 that include avatar images by extracting and identifying feature information on motions of the singers performing and the audience in the audience seats included in the obtained image data. The electronic apparatus 200 may provide, by controlling the display 260 to display the virtual space images 820 and 830, an experience in virtual space to the singers and the audience similar to as if watching a performance by the singers together with a number of people in an actual concert scene from each of one's own space (e.g., a home).

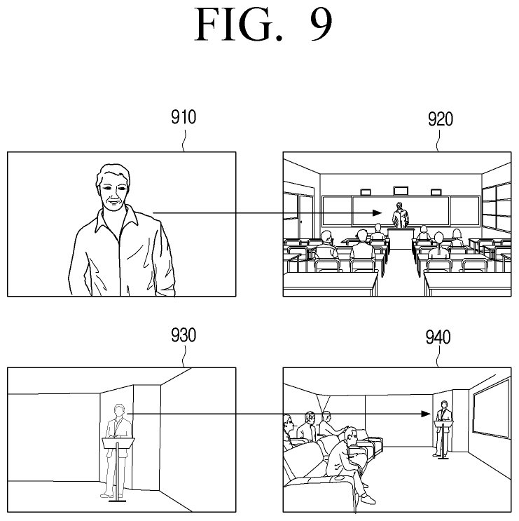

FIG. 9 is a diagram illustrating an avatar image in virtual space generated based on image data according to an embodiment of the disclosure.

The electronic apparatus 200 may obtain images 910 and 930 which captured a teacher teaching in a lecture room with the camera 240. Here, the image obtained by the electronic apparatus by capturing with the camera 240 may include an image which captured not only the teacher but also the students. The electronic apparatus 200 may obtain virtual space images 920 and 940 that include avatar images by extracting and identifying feature information on the motions of the teacher included in the obtained images 910 and 930. The electronic apparatus 200 may provide, by controlling the display 260 to display the virtual space images 920 and 940, an experience in virtual space similar to as if actually taking class by the teacher and the students in a lecture room from each of one's own space (e.g., a home).

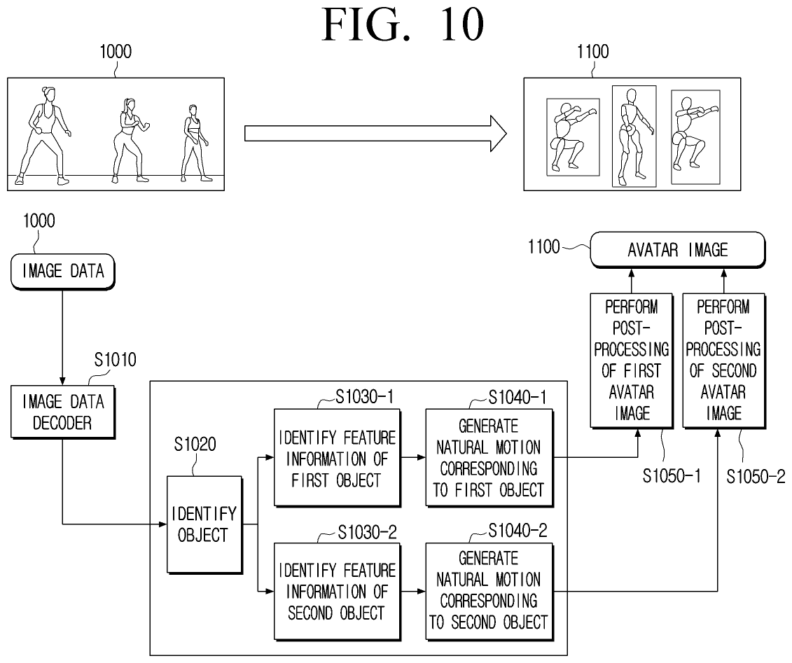

An embodiment of an overall flow of the operations of the electronic apparatus 200 according to the disclosure will be described below through FIG. 10 to FIG. 13.

FIG. 10 is a flowchart illustrating an avatar image obtaining process in virtual space corresponding to a plurality of objects included in image data according to an embodiment of the disclosure.

The electronic apparatus 200 may obtain an avatar image 1100 in virtual space from image data 1000.

The electronic apparatus 200 may obtain image frame information by inputting the image data 1000 which is captured from the camera 240 or pre-stored in the memory 210 or the external apparatus in an image data decoder (S1010). The electronic apparatus 200 may identify an object included in the obtained image frame (S1020). The electronic apparatus 200 may identify feature information of a first object included in the image frame (S1030-1), and identify feature information of a second object included in the image frame (S1030-2).

The electronic apparatus 200 may obtain a first avatar image by generating a natural motion corresponding to the first object (S1040-1). The electronic apparatus 200 may obtain a second avatar image by generating a natural motion corresponding to the second object (S1040-2). Here, the electronic apparatus 200 may generate a motion and obtain an avatar image based on the temporal filtering or the motion constraint information to generate a motion which coincides with reality, and obtain the virtual space image that includes the avatar image.

The electronic apparatus 200 may perform post-processing on the obtained first avatar image, the second avatar image, and the virtual space image (S1050-1 and S1050-2). Here, the post-processing may include image encoding, compression, and the like.

The electronic apparatus 200 may store the post-processed virtual space image in the memory 210 or transmit the same to the external apparatus such as the server. In addition thereto, the processor 220 may control the display 260 to display the virtual space image.

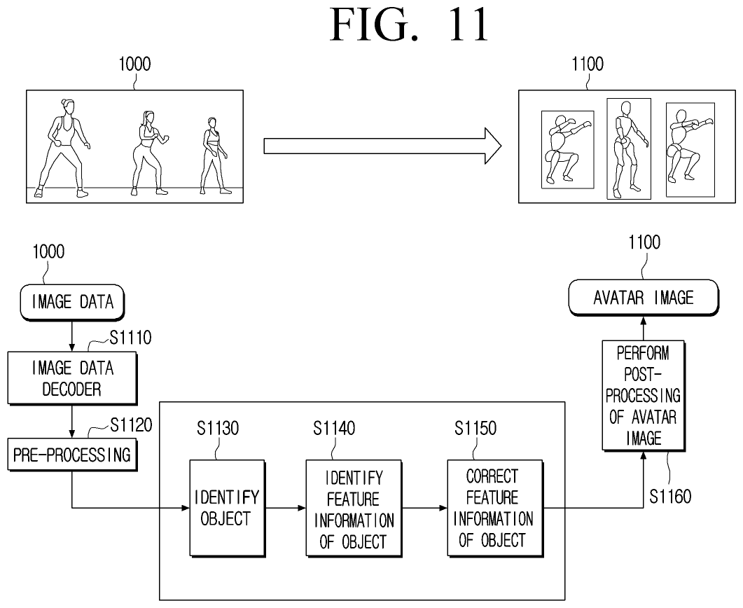

FIG. 11 is a flowchart illustrating an avatar image obtaining process in virtual space by correcting feature information of objects included in image data according to an embodiment of the disclosure.

Referring to FIG. 11, the electronic apparatus 200 may obtain information on an image frame by inputting the image data 1000 in the image data decoder (S1110). The electronic apparatus 200 may perform pre-processing on the obtained image frame (S1120). Here, the pre-processing may include image frame re-sizing, multi-frame extraction, and the like.

The electronic apparatus 200 may identify an object included in the pre-processed image frame (S1130). The electronic apparatus 200 may extract and identify feature information of the identified object (S1140). The electronic apparatus 200 may obtain an avatar image corresponding to the object by correcting or processing feature information of the extracted and identified object (S1150). At this time, the electronic apparatus 200 may utilize the temporal filtering information or the motion constraint information when correcting or processing the feature information. The electronic apparatus 200 may obtain a virtual space image which includes a natural avatar image which coincides more with an actual appearance by correcting or processing the feature information utilizing the temporal filtering information or the motion constraint information.

The electronic apparatus 200 may perform post-processing on the virtual space image that includes the obtained avatar image (S1160). The electronic apparatus 200 may store the virtual space image that includes the post-processed avatar image in the memory 210, or transmit the same to the external apparatus such as the server, or control the display 260 to display on a screen.

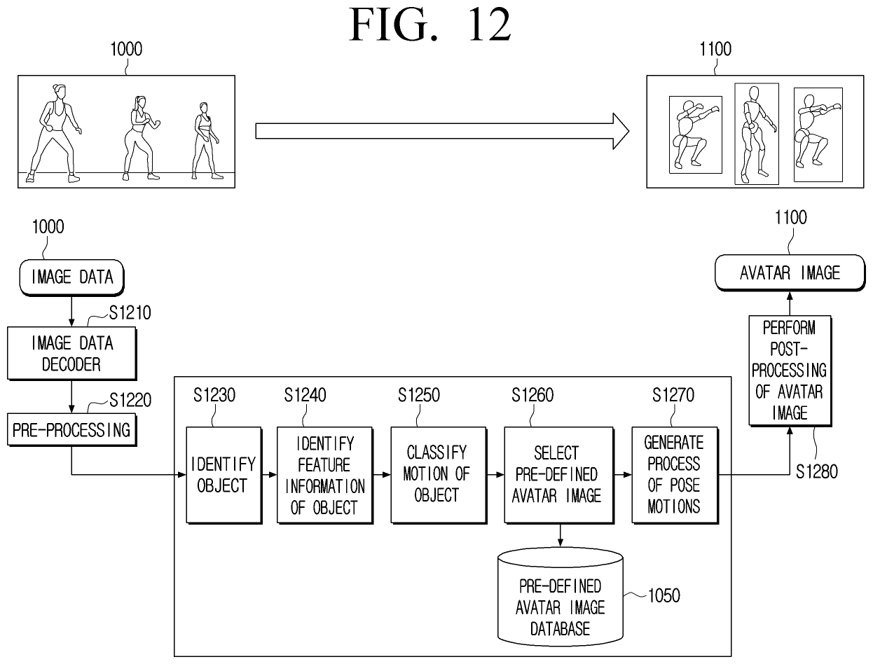

FIG. 12 is a flowchart illustrating a process of obtaining an avatar image in virtual space based on a motion of an object included in image data and pre-defined avatar motion information according to an embodiment of the disclosure.

Referring to FIG. 12, the electronic apparatus 200 may obtain information on an image frame by inputting the image data 1000 in the image data decoder (S1210). The electronic apparatus 200 may perform pre-processing on the obtained image frame (S1220).

The electronic apparatus 200 may identify an object included in the pre-processed image frame (S1230). The electronic apparatus 200 may extract and identify feature information of the identified object (S1240). The electronic apparatus 200 may classify a motion of the object based on the feature information of the identified object (S1250). Here, a type of the motion that is being classified may mean types of various motions which can be taken by the object. For example, various motions such as, for example, and without limitation, a motion of squatting with open arms, a motion of standing in attention, a motion of running, and the like may constitute the types of motions or types of poses. The electronic apparatus 200 may identify whether the motion information or the feature information of the object corresponds to the pre-defined avatar motion information or the pre-defined avatar image information included in a pre-defined avatar image database 1050 based on the motion information of the classified object (S1260). The electronic apparatus 200 may obtain an avatar image corresponding to the object based on the pre-defined avatar motion information or the pre-defined avatar image information identified as corresponding to the motion information or the feature information of the object. The electronic apparatus 200 may obtain an intermediate avatar image by generating a motion necessary in indicating the process of motions (S1270). The electronic apparatus 200 may obtain the virtual space image that includes the final avatar image indicating an entire process of motions based on the obtained avatar image and the intermediate avatar image.

The electronic apparatus 200 may perform post-processing on the virtual space image that includes the final avatar image (S1280).

The electronic apparatus 200 may store the virtual space image that includes the post-processed avatar image in the memory 210, or transmit the same to the external apparatus such as the server, or control the display 260 to display the same on the screen.

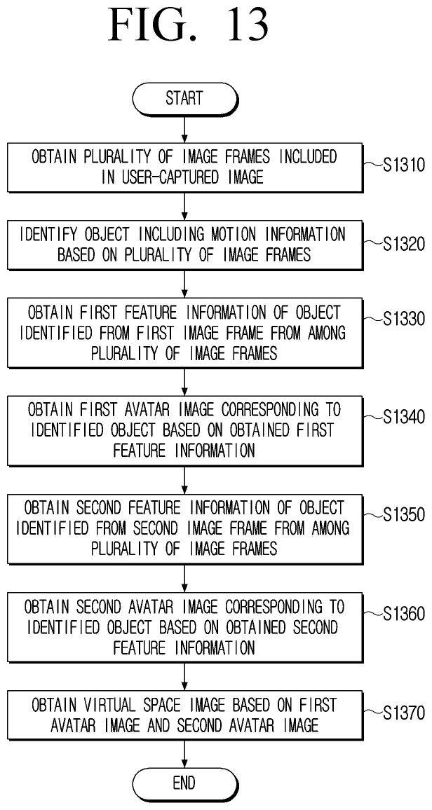

FIG. 13 is a flowchart illustrating an operation of the electronic apparatus 200 according to an embodiment of the disclosure.

Referring to FIG. 13, the electronic apparatus 200 according to the disclosure may obtain a plurality of image frames included in a user-captured image through an image decoder (S1310). Here, the image may be a real-time image captured through the camera 240, but is not limited thereto, and may be an image that is captured in advance and stored in the memory 210 or the external apparatus.

The electronic apparatus 200 may identify an object that includes motion information based on the plurality of image frames (S1320). Here, the motion information may be information on a motion of the object, or may include feature information on the motion of the object. The electronic apparatus 200 may obtain, based on the first object and the second object including motion information being identified based on the plurality of image frames, the feature information of the first object based on the first extraction method and obtain the feature information of the second object based on the second extraction method from the first image frame.

The electronic apparatus 200 may obtain first feature information of the object identified from the first image frame from among the plurality of image frames (S1330). The electronic apparatus 200 may obtain a first avatar image corresponding to the identified object based on the obtained first feature information (S1340). The electronic apparatus 200 may obtain the feature information of the first object based on the first extraction method and obtain the feature information of the second object based on the second extraction method from the second image frame. Here, the first feature information may be information on a form, a shape, and a length of the identified object, an angle of a bending portion which is included in the object, a position of each configuration, a position of a joint, a bending portion, or a characteristic portion that form the object, and the like.

The electronic apparatus 200 may obtain second feature information of the object identified from the second image frame from among the plurality of image frames (S1350). The electronic apparatus 200 may obtain a second avatar image corresponding to the identified object based on the obtained second feature information (S1360). The electronic apparatus 200 may obtain an avatar image corresponding to the first object based on the feature information of the first object, and obtain an avatar image corresponding to the second object based on the feature information of the second object. In addition, the electronic apparatus 200 may obtain an avatar image corresponding to the feature information of the first object based on first motion generating information, and obtain an avatar image corresponding to the feature information of the second object based on second motion generating information. Here, the first motion generating information and the second motion generating information may be different motion constraint information.

The electronic apparatus 200 may identify the first motion type of the object based on the first feature information of the identified object. The electronic apparatus 200 may identify the first pre-defined avatar motion information corresponding to the identified first motion type. The first pre-defined avatar motion information may include the first motion image, and the second pre-defined avatar motion information may include the second motion image. The electronic apparatus 200 may obtain the first avatar image based on the first pre-defined avatar motion information. The electronic apparatus 200 may identify the second motion type of the object based on the second feature information of the identified object. The electronic apparatus 200 may identify the second pre-defined avatar motion information corresponding to the identified second motion type. The electronic apparatus 200 may obtain the second avatar image based on the second pre-defined avatar motion information. The electronic apparatus 200 may obtain the intermediate avatar image of the first avatar image and the second avatar image based on the first avatar image and the second avatar image. The electronic apparatus 200 may obtain the final avatar image based on the first avatar image, the second avatar image, and the intermediate avatar image.

The electronic apparatus 200 may obtain the virtual space image based on the first avatar image and the second avatar image (S1370).

According to an embodiment, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online (e.g., downloaded or uploaded) through an application store (e.g., PLAYSTORE™) or directly between two user apparatuses (e.g., smartphones). In the case of online distribution, at least a portion of the computer program product (e.g., a downloadable app) may be stored at least temporarily in the machine-readable storage medium such as a server of a manufacturer, a server of an application store, or a memory of a relay server, or temporarily generated.

While the disclosure has been shown and described with reference to example embodiments thereof, the disclosure is not limited to the embodiments described and various modifications may be made therein by those skilled in the art to which this disclosure pertains without departing from the spirit and scope of the disclosure, and such modifications shall not be understood as separate from the technical concept or outlook of the present disclosure.

What is claimed is:

1. An electronic apparatus, comprising:
one or more processors; and
at least one memory storing instructions that, when executed by the one or more processors, cause the electronic apparatus to:
obtain a plurality of image frames in a user-captured image stored in the at least one memory;
identify an object which comprises motion information based on the plurality of image frames;
obtain first feature information of the object from a first image frame from among the plurality of image frames;
obtain a first avatar image corresponding to the object based on the first feature information;
obtain second feature information of the object from a second image frame from among the plurality of image frames;
obtain a second avatar image corresponding to the object based on the second feature information; and
obtain a virtual space image based on the first avatar image and the second avatar image.

2. The electronic apparatus of claim 1, wherein the one or more processors are configured to execute the instructions to cause the electronic apparatus to:
identify, based on the plurality of image frames, a first object comprising first motion information and a second object comprising second motion information,
obtain, from the first image frame, third feature information of the first object based on a first extraction method and fourth feature information of the second object based on a second extraction method;
obtain, from the second image frame, fifth feature information of the first object based on the first extraction method and sixth feature information of the second object based on the second extraction method; and
obtain a third avatar image corresponding to the first object based on the third feature information and the fifth feature information, and obtain a fourth avatar image corresponding to the second object based on the fourth feature information and the sixth feature information.

3. The electronic apparatus of claim 1, wherein the one or more processors are configured to execute the instructions to cause the electronic apparatus to:
obtain from the first image frame, based on a first object comprising first motion information and a second object comprising second motion information being identified based on the plurality of image frames, third feature information of the first object and fourth feature information of the second object;
obtain from the second image frame, fifth feature information of the first object and sixth feature information of the second object;
obtain a third avatar image corresponding to the third feature information and the fifth feature information based on first motion generating information, and
obtain a fourth avatar image corresponding to the fourth feature information and the sixth feature information based on second motion generating information.

4. The electronic apparatus of claim 3, wherein the first motion generating information comprises first motion constraint information, the second motion generating information comprises second motion constraint information, and the first motion constraint information is different from the second motion constraint information.

5. The electronic apparatus of claim 1, wherein the one or more processors are configured to execute the instructions to cause the electronic apparatus to:
identify a first motion type of the object based on the first feature information;
identify first pre-defined avatar motion information corresponding to the first motion type;
obtain the first avatar image based on the first pre-defined avatar motion information;
identify a second motion type of the object based on the second feature information;
identify second pre-defined avatar motion information corresponding to the second motion type;
obtain the second avatar image based on the second pre-defined avatar motion information;
obtain an intermediate avatar image of the first avatar image and the second avatar image based on the first avatar image and the second avatar image; and
obtain a final avatar image based on the first avatar image, the second avatar image, and the intermediate avatar image.

6. The electronic apparatus of claim 5, wherein the first pre-defined avatar motion information comprises a first motion image, and the second pre-defined avatar motion information comprises a second motion image, and
wherein the one or more processors are configured to execute the instructions to cause the electronic apparatus to:
identify a first avatar motion image corresponding to the first motion type based on the first pre-defined avatar motion information, and identify a second avatar motion image corresponding to the second motion type based on the second pre-defined avatar motion information;
obtain the first avatar image based on the first avatar motion image and information on the object;
obtain the second avatar image based on the second avatar motion image and the information on the object;
obtain the intermediate avatar image of the first avatar image and the second avatar image based on the first avatar image and the second avatar image; and
obtain the final avatar image based on the first avatar image, the second avatar image, and the intermediate avatar image.

7. The electronic apparatus of claim 5, wherein pre-defined avatar motion information corresponding to a plurality of motion types is stored in the at least one memory or an external apparatus, and
wherein the one or more processors are configured to execute the instructions to cause the electronic apparatus to:
transmit, based on the pre-defined avatar motion information being stored in the external apparatus, information on the first motion type and the second motion type to the external apparatus, and receive the first pre-defined avatar motion information and the second pre-defined avatar motion information from the external apparatus.

8. The electronic apparatus of claim 1, further comprising a display,
wherein the one or more processors are configured to execute the instructions to cause the electronic apparatus to control the display to display the virtual space image.

9. The electronic apparatus of claim 1, wherein the one or more processors are configured to execute the instructions to cause the electronic apparatus to:
obtain a first avatar motion image corresponding to the object based on the first feature information;
obtain a second avatar motion image corresponding to the object based on the second feature information; and
obtain the virtual space image by applying temporal filtering to the first avatar motion image and the second avatar motion image.

10. A control method of an electronic apparatus, comprising:
identifying an object which comprises motion information based on a plurality of image frames in a user-captured image;
obtaining first feature information of the object from a first image frame from among the plurality of image frames;
obtaining a first avatar image corresponding to the object based on the first feature information;
obtaining second feature information of the object from a second image frame from among the plurality of image frames;
obtaining a second avatar image corresponding to the object based on the second feature information; and
obtaining a virtual space image based on the first avatar image and the second avatar image.

11. The control method of claim 10, wherein the identifying the object comprises identifying, based on the plurality of image frames, a first object comprising first motion information and a second object comprising second motion information,
wherein the obtaining the first feature information comprises obtaining, from the first image frame, third feature information of the first object based on a first extraction method and fourth feature information of the second object based on a second extraction method,
wherein the obtaining the second feature information comprises obtaining, from the second image frame, fifth feature information of the first object based on the first extraction method and sixth feature information of the second object based on the second extraction method, and
wherein the obtaining the first avatar image and the obtaining the second avatar image comprise obtaining a third avatar image corresponding to the first object based on the third feature information and the fifth feature information, and obtaining a fourth avatar image corresponding to the second object based on the fourth feature information and the sixth feature information.

12. The control method of claim 10, wherein the identifying the object comprises identifying, based on the plurality of image frames a first object comprising first motion information and a second object comprising second motion information,
wherein the obtaining the first feature information comprises obtaining, from the first image frame, third feature information of the first object and fourth feature information of the second object,
wherein the obtaining the second feature information comprises obtaining, from the second image frame, fifth feature information of the first object and sixth feature information of the second object, and
wherein the obtaining the first avatar image and the obtaining the second avatar image comprise obtaining a third avatar image corresponding to the third feature information and the fifth feature information based on first motion generating information, and obtaining a fourth avatar image corresponding to the fourth feature information and the sixth feature information based on second motion generating information.

13. The control method of claim 12, wherein the first motion generating information comprises first motion constraint information, the second motion generating information comprises second motion constraint information, and the first motion constraint information is different from the second motion constraint information.

14. The control method of claim 10, wherein the obtaining the first avatar image comprises:
identifying a first motion type of the object based on the first feature information;
identifying first pre-defined avatar motion information corresponding to the first motion type; and
obtaining the first avatar image based on the first pre-defined avatar motion information, and
wherein the obtaining the second avatar image comprises:
identifying a second motion type of the object based on the second feature information;
identifying second pre-defined avatar motion information corresponding to the second motion type; and
obtaining the second avatar image based on the second pre-defined avatar motion information, and
wherein the obtaining the virtual space image comprises:
obtaining an intermediate avatar image of the first avatar image and the second avatar image based on the first avatar image and the second avatar image; and
obtaining a final avatar image based on the first avatar image, the second avatar image, and the intermediate avatar image.

15. The control method of claim 14, wherein the first pre-defined avatar motion information comprises a first motion image, and the second pre-defined avatar motion information comprises a second motion image,
wherein the obtaining the first avatar image comprises:
identifying a first avatar motion image corresponding to the first motion type based on the first pre-defined avatar motion information; and
obtaining the first avatar image based on the first avatar motion image and information on the object,
wherein the obtaining the second avatar image comprises:
identifying a second avatar motion image corresponding to the second motion type based on the second pre-defined avatar motion information; and
obtaining the second avatar image based on the second avatar motion image and the information on the object, and
wherein the obtaining the virtual space image comprises:
obtaining the intermediate avatar image of the first avatar image and the second avatar image based on the first avatar image and the second avatar image; and
obtaining the final avatar image based on the first avatar image, the second avatar image, and the intermediate avatar image.

16. The control method of claim 14, wherein the obtaining the first avatar image and the obtaining the second avatar image comprise:
transmitting, based on the pre-defined avatar motion information being stored in an external apparatus, information on the first motion type and the second motion type to the external apparatus; and
receiving the first pre-defined avatar motion information and the second pre-defined avatar motion information from the external apparatus.

17. The control method of claim 10, further comprising displaying the virtual space image.

18. The control method of claim 10, further comprising:
obtaining a first avatar motion image corresponding to the object based on the obtained first feature information; and
obtaining a second avatar motion image corresponding to the object based on the obtained second feature information, and
wherein the obtaining the virtual space image comprises obtaining the virtual space image by applying temporal filtering to the first avatar motion image and the second avatar motion image.
